(19) United States
(12) Patent Application Publication
(10) Pub. No.: US 2011/0286438 A1
(43) Pub. Date: Nov. 24, 2011

(54) COMMUNICATION SYSTEM, COMMUNICATION APPARATUS, AND COMMUNICATION METHOD

(75) Inventor: Hirotaka KYUTOKU, Nagoya-shi (JP)

(73) Assignee: Buffalo Inc., Nagoya-shi (JP)

(21) Appl. No.: 13/106,205

(22) Filed: May 12, 2011

(30) Foreign Application Priority Data
May 20, 2010 (JP) 2010-115936

(51) Int. Cl. H04W 84/02

(52) U.S. Cl. 370/338

(57) ABSTRACT

A communication system includes an information processing apparatus capable of communicating via the Internet, an image reproducing apparatus for reproducing image data and displaying images reproduced from the image data, and a communication apparatus which is connected to the image reproducing apparatus and is provided with a global IP address. The information processing apparatus includes a communication establishing unit for establishing an IP-communication channel via the Internet linked with the communication apparatus provided with the global IP address, and an image transmitter for transmitting image data to the communication apparatus via the IP-communication channel. The communication apparatus includes an image receiver for receiving the image data transmitted by the image transmitter, and an image relaying unit for relaying the image data received by the image receiver to the image reproducing apparatus. The image reproducing apparatus reproduces the image data relayed by the image relaying unit and displays an image reproduced from the image data.

### CROSS REFERENCE TO RELATED APPLICATION

This application is based upon and claims the benefit of priority from the prior Japanese Patent Application No. 2010-115936 filed on May 20, 2010; the entire contents of which are incorporated herein by reference.

### BACKGROUND OF THE INVENTION

1. Field of the Invention

This invention relates to a communication system, a communication apparatus and a communication method using an image reproducing apparatus.

2. Description of the Related Art

Along with the wide diffusion of digital cameras, photo-frame shaped image reproducing apparatuses (a.k.a. digital photo frames) have become widely used as apparatuses for providing an easy way to view images of image data obtained by the use of the digital cameras, without printing them out.

The users connect storage media storing therein image data, such as USB (universal serial bus) memories and memory cards, to image reproducing apparatuses, and operate the image reproducing apparatuses. In response to the operations by the users, the image reproducing apparatuses load the image data in the storage media, and display the images reproduced from the loaded image data.

Image reproducing apparatuses for use with a wireless LAN (Local Area Network) have already been put into a practical use in recent years (see, for example, Japanese Patent Application Publication No. 2010-4118). A private IP address is given to each wireless-LAN-linked image reproducing apparatus, and thereby the image reproducing apparatus is allowed to perform IP-communication with other devices on the LAN (e.g. home network).

Furthermore, a wireless-LAN-linked image reproducing apparatus can read image data from another device on the LAN in response to an operation by a user, and reproduce the read image data for display.

Some users (e.g. elderly people) who are not good at operating electronic devices find it difficult to operate the image reproducing apparatuses at their will. Hence, there is a demand for sending image data via the Internet from a PC server or the like located in a house to an image reproducing apparatus located in another house (e.g. a house of an elderly person) and showing images of the image data to a person not good at operation.

An existing wireless-LAN-linked image reproducing apparatuses can indeed read image data from another device on the LAN, but cannot receive image data from remote devices via the Internet. Hence, the existing image reproducing apparatus cannot be free from the problem that it fails to satisfy the above-mentioned demand.

### SUMMARY OF THE INVENTION

The object of this invention is to provide a communication system, a communication apparatus, and a communication method that allow a user in a remote place to view images by using an image reproducing apparatus without imposing any difficulty in operation on the user.

In order to solve the problem mentioned above, this invention has the following features.

According to one of the features of this invention, there is provided a communication system comprising: an information processing apparatus (e.g. server apparatus 200) capable of communicating via the Internet (Internet 10); an image reproducing apparatus (e.g. digital photo frame 500) for reproducing image data and displaying images reproduced from the image data; and a communication apparatus (e.g. USB wireless LAN terminal 400) which is connected to the image reproducing apparatus and provided with a global IP (Internet Protocol) address, wherein the information processing apparatus includes: a communication establishing unit (communication establishing unit 231) for establishing via the Internet an IP-communication channel linked with the communication apparatus provided with the global IP address; and an image transmitter (image transmitter 233) for transmitting image data to the communication apparatus via the IP-communication channel established by the communication establishing unit, the communication apparatus includes: an image receiver (image receiver 432) for receiving the image data transmitted by the image transmitter; and an image relaying unit (image relaying unit 433) for relaying the image data received by the image receiver to the image reproducing apparatus, and the image reproducing apparatus reproduces the image data relayed by the image relaying unit and displays images reproduced from the image data.

With such a feature, the information processing apparatus establishes an IP-communication channel linked with the communication apparatus set with a global IP address, and transmits image data through the IP-communication channel to the communication apparatus. The communication apparatus receives the image data, and relays the image data to the image reproducing apparatus. Then, the image reproducing apparatus reproduces the image data relayed by the communication apparatus and displays images reproduced from the image data.

Accordingly, image data can be sent, via the Internet, from an information processing apparatus located in a house to an image reproducing apparatus located in another house. Thus, even a user who is not good at operating electronic devices (e.g. an elderly person) can view images of the image data.

According to another feature of a communication system of this invention, the image transmitter transmits the image data to the communication apparatus in compliance with the IP, the communication apparatus further includes a communication-apparatus-side interface (e.g. USB interface 420) built in compliance with a predetermined interface protocol and connected to the image reproducing apparatus, and the image relaying unit performs protocol conversion from the IP to the predetermined interface protocol with respect to the image data received by the image receiver, and then relays the resultant image data to the image reproducing apparatus via the communication-apparatus-side interface.

According to another feature of a communication system of this invention, the information processing apparatus further includes: an information-processing-apparatus-side interface (e.g. USB interface 210) which is built in compliance with the predetermined interface protocol and to which a storage medium (e.g. USB memory 100) is connected; and an image reading unit (image reading unit 232) for reading image data from the storage medium connected to the information-processing-apparatus-side interface, and the image transmitter performs protocol conversion from the predetermined interface protocol to the IP with respect to the image data read by the image reading unit, and then transmits the resultant image data to the communication apparatus.

According to another feature of a communication system of this invention, the predetermined interface protocol is the USB (universal serial bus) protocol.

According to another feature of a communication system of this invention, the communication apparatus further includes a wireless LAN communication unit (wireless LAN communication unit 410) for communicating wirelessly with a wireless LAN base station (wireless LAN base station 300) connected to the Internet, the image transmitter transmits image data to the communication apparatus via the Internet and the wireless LAN base station, and the image receiver receives the image data via the wireless LAN communication unit.

According to another feature of this invention, there is provided a communication apparatus comprising: a communication-apparatus-side interface which is built in compliance with a predetermined interface protocol and which is connected to an image reproducing apparatus for reproducing image data and displaying images reproduced from the image data; an image receiver for receiving image data transmitted by an information processing apparatus by using an IP-communication channel via the Internet after a global IP address has been set in the communication apparatus, and an image relaying unit for performing protocol conversion from the IP to the predetermined interface protocol with respect to the image data received by the image receiver, and then relaying the resultant image data to the image reproducing apparatus via the communication-apparatus-side interface.

According to another feature of this invention, there is provided a communication method comprising: the step of causing an information processing apparatus capable of communicating via the Internet, to establish via the Internet an IP-communication channel reaching a communication apparatus which is connected to the image reproducing apparatus by using a predetermined interface and is provided with a global IP address; the step of causing the information processing apparatus to transmit image data to the communication apparatus by using the IP-communication channel established above; the step of causing the communication apparatus to receive the image data transmitted by the information processing apparatus and to relay the received image data to the image reproducing apparatus; and the step of causing the image reproducing apparatus to receive the image data relayed by the communication apparatus and to reproduce the received image data for display.

### BRIEF DESCRIPTION OF THE DRAWINGS

FIG. 1 shows in block diagram the configuration of a communication system according to an embodiment of this invention.

FIG. 2 shows in perspective view a digital photo frame and a USB wireless LAN terminal according to the embodiment of this invention.

FIG. 3 shows in block diagram the configuration of a server apparatus according to the embodiment of this invention.

FIG. 4 shows in block diagram the configuration of the USB wireless LAN terminal according to the embodiment of this invention.

FIG. 5 is a flowchart explaining the operation of the communication system according to the embodiment of this invention.

### DESCRIPTION OF THE EMBODIMENTS

An embodiment of this invention is described with reference to the drawings. Throughout the drawings, the same or similar components are labeled with the same or similar reference numerals.

### (1) Configuration of Communication System

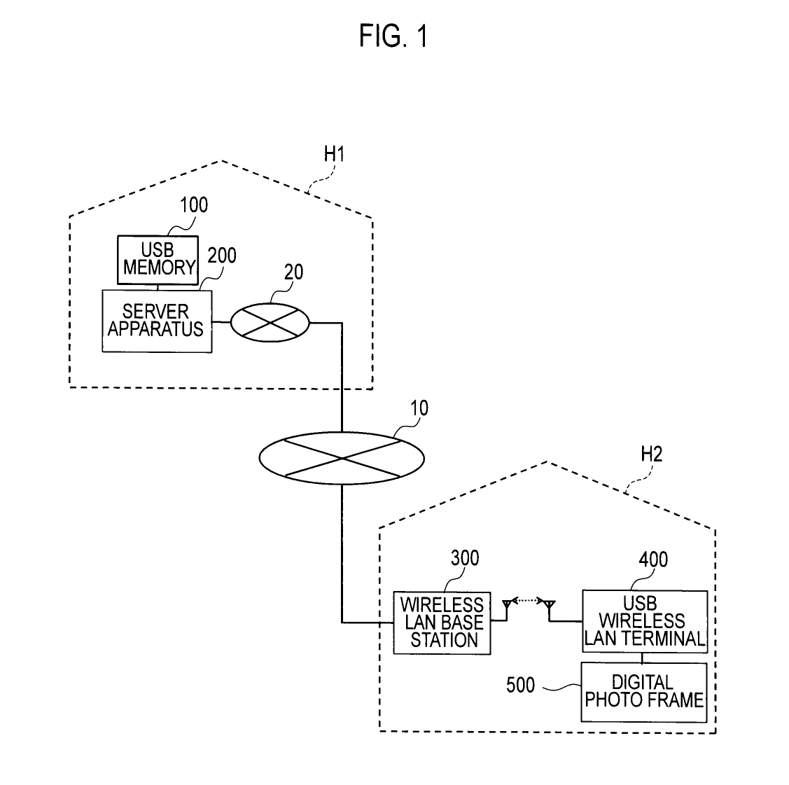

FIG. 1 is a diagram of the configuration of a communication system according to the embodiment of this invention. The communication system shown in FIG. 1 includes a USB memory 100, a server apparatus 200, a home network 20, the Internet 10, a wireless LAN base station 300, a USB wireless LAN terminal 400, and a digital photo frame 500.

The server apparatus 200 and the home network 20 are located in a house H1. The server apparatus 200 includes a USB interface, and the USB memory 100 where image data are stored is connected to the USB interface. The image data are still-image data acquired by using a digital camera or the like. The server apparatus 200 is connected to the Internet 10 via the home network 20. The server apparatus 200 of this embodiment corresponds to an information processing apparatus capable of communicating via the Internet 10. The USB memory 100 corresponds to a storage medium connected to the information processing apparatus.

The wireless LAN base station 300 and the digital photo frame 500 are located in a house H2. The digital photo frame 500 includes a USB interface, and the USB wireless LAN terminal 400 is connected to the USB interface. The wireless LAN base station 300 is connected to the Internet 10. The wireless LAN base station 300 and the USB wireless LAN terminal 400 communicate wirelessly in compliance with the wireless LAN standards (e.g. IEEE802.11a/b/g/n).

The digital photo frame 500 of this embodiment corresponds to an image reproducing apparatus capable of reproducing image data to display images. The USB wireless LAN terminal 400 corresponds to a communication apparatus connected to the image reproducing apparatus.

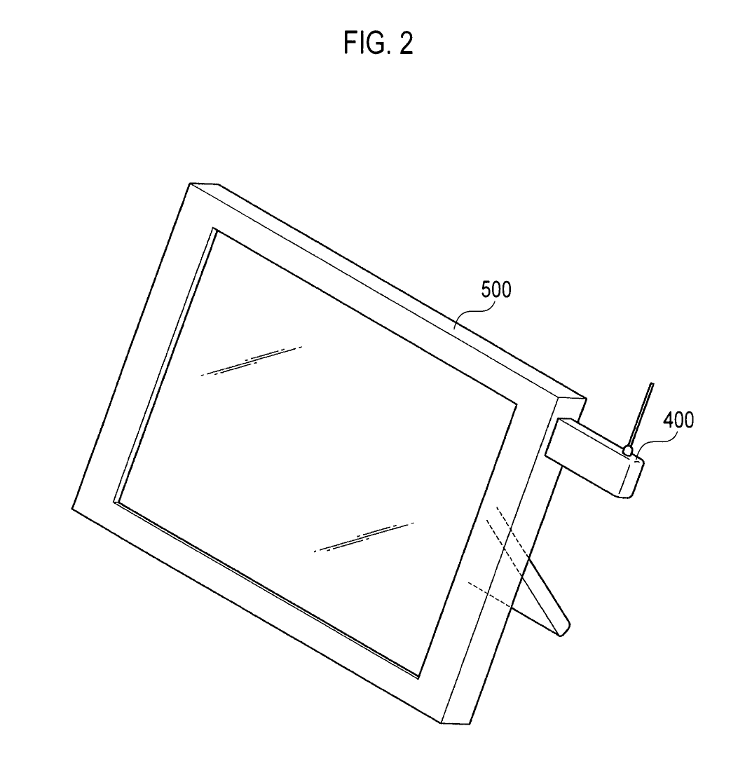

FIG. 2 shows in perspective view the digital photo frame 500 and the USB wireless LAN terminal 400. In FIG. 2, the USB wireless LAN terminal 400 as being connected to the digital photo frame 500 is shown.

As FIG. 2 shows, the USB wireless LAN terminal 400 is connected directly to the digital photo frame 500 without using any cable. The USB wireless LAN terminal 400 and the digital photo frame 500 are constructed in compliance with USB protocols (such as USB 2.0 or 3.0). The digital photo frame 500 supplies electric power to drive the USB wireless LAN terminal 400.

If a USB device is connected to the digital photo frame 500, the digital photo frame 500 automatically reproduces images from the image data stored in the USB device.

The digital photo frame 500 may not necessarily have a wireless LAN communication function. The digital photo frame 500 without the wireless-LAN communication function has neither a private IP address nor a global IP address. The digital photo frame 500 with the wireless LAN communication function has a private IP address, but has no global IP address.

### (2) Configuration of Server Apparatus

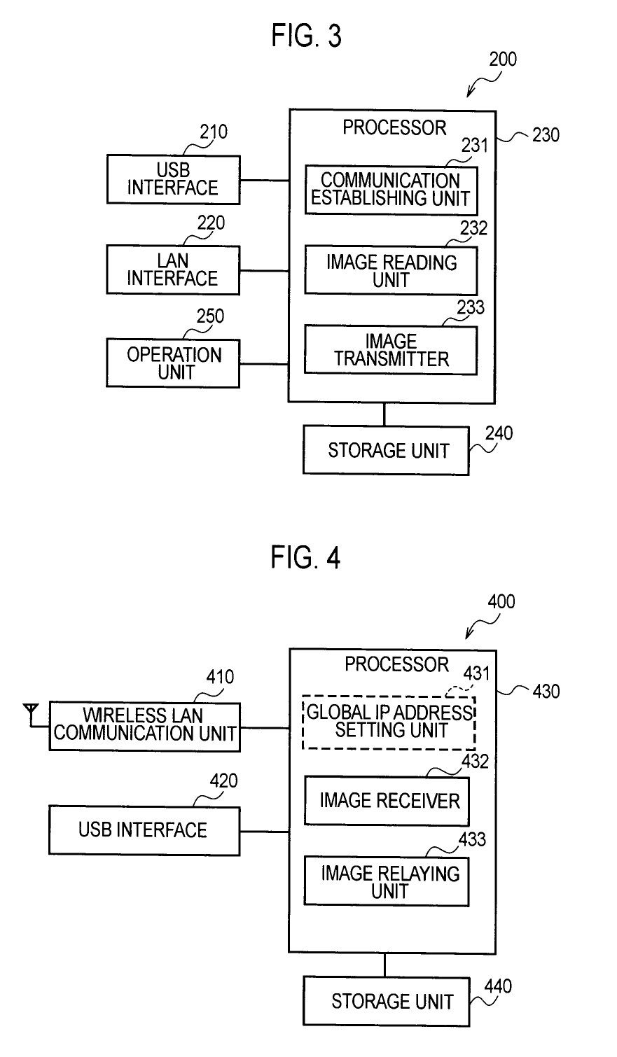

FIG. 3 is a block diagram of the configuration of the server apparatus 200. As shown in FIG. 3, the server apparatus 200 includes a USB interface 210, a LAN interface 220, a processor 230, a storage unit 240, and an operation unit 250.

The USB interface 210 is where the USB memory 100 is connected. There may be more than one USB interface 210. The LAN interface 220 is connected to the home network 20.

A CPU or the like serves as the processor 230. The processor 230 executes the programs stored in the storage unit 240 to perform various kinds of processing. A memory or the like serves as the storage unit 240. The storage unit 240 has both the function of storing the programs to be executed by the processor 230 and the function of providing a work area for the processor 230. The operation unit 250 accepts the inputs by the user of the server apparatus 200.

The processor 230 includes a communication establishing unit 231, an image reading unit 232, and an image transmitter 233.

The communication establishing unit 231 establishes a VPN (virtual private network) via the Internet 10 between the server apparatus 200 and the USB wireless LAN terminal 400 provided with a global IP address. Existing techniques can be employed to establish a VPN.

In response to the input operation performed by the user through the operation unit 250, the image reading unit 232 reads image data from the USB memory 100 connected to the USB interface 210.

The image transmitter 233 performs protocol conversion from the USB protocol to the IP with respect to the image data read by the image loading unit 232 and then sends the resultant image data to the USB wireless LAN terminal 400 via the LAN interface 220. Here, the image transmitter 233 groups into IP-packets the image data as serial data that is in compliance with the USB protocol before sending the image data.

### (3) Configuration of USB Wireless LAN Terminal

FIG. 4 is a block diagram of the configuration of the USB wireless LAN terminal 400.

As shown in FIG. 4, the USB wireless LAN terminal 400 includes a wireless LAN communication unit 410, a USB interface 420, a processor 430, and a storage unit 440.

The wireless LAN communication unit 410 communicates wirelessly with the wireless LAN base station 300 in compliance with the wireless LAN standards. The USB interface 420 is connected to the digital photo frame 500.

A CPU or the like serves as the processor 430. The processor 430 performs various kinds of processing by executing the programs stored in the storage unit 440. A memory or the like serves as the storage unit 440. The storage unit 440 has both the function of storing the programs to be executed by the processor 430 and the function of providing a work area for the processor 430.

The processor 430 includes a global IP address setting unit 431, an image receiver 432, and an image relaying unit 433.

The global IP address setting unit 431 uses existing techniques to set a global IP address for the USB wireless LAN terminal 400. If a global IP address is previously stored in the storage unit 440, the global IP address setting unit 431 may be excluded.

After a global IP address has been set in the image receiver 432, the image receiver 432 receives image data transmitted by the server apparatus 200 via the VPN. The image receiver 432 receives the image data via the wireless LAN communication unit 410.

The image relaying unit 433 performs protocol conversion from the IP to the USB protocol with respect to the image data received by the image receiver 432, and then relays the resultant image data to the digital photo frame 500 via the USB interface 420. Here, the image relaying unit 433 converts the image data, which have been grouped into the IP-packets, into serial data that is in compliance with the USB protocol, and then relays the serial image data. A technique known as the “USB over IP” may be employed to this end.

### (4) Operations of Communication System

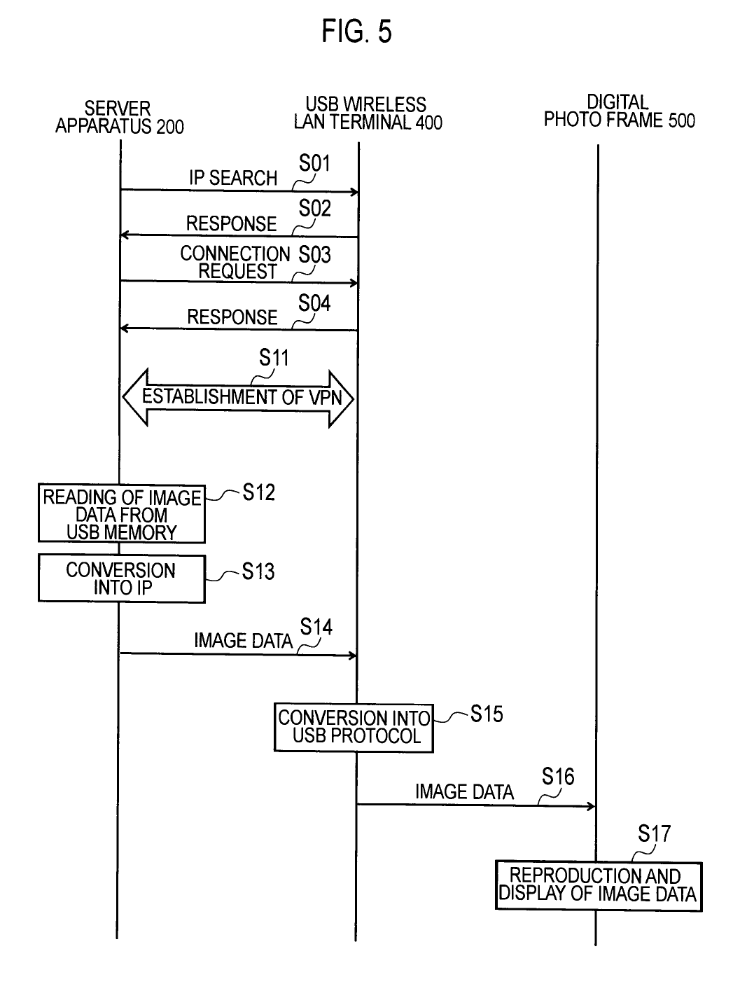

FIG. 5 is a flowchart explaining the operation of the communication system according to this embodiment.

In step S01, the communication establishing unit 231 of the server apparatus 200 transmits to the USB wireless LAN terminal 400 a signal for searching for the global IP address of the USB wireless LAN terminal 400.

In step S02, the communication establishing unit 231 receives the response to the searching signal, and then transmits a connection request to the USB wireless LAN terminal 400 in step S03. Upon receiving the response to the connection request (in step S04), the communication establishing unit 231 sets the global IP address of the USB wireless LAN terminal 400. In this way, the communication establishing unit 231 of the server apparatus 200 establishes a VPN via the Internet 10 between the server apparatus 200 and the USB wireless LAN terminal 400 set with the global IP address (in step S11).

In step S12, in response to the operational input which the operation unit 250 received from the user, the image reading unit 232 of the server apparatus 200 reads image data from the USB memory 100 connected to the USB interface 210.

In step S13, the image transmitter 233 of the server apparatus 200 performs protocol conversion from the USB protocol to the IP with respect to the image data read by the image reading unit 232.

In step S14, the image transmitter 233 of the server apparatus 200 transmits the IP-packets of the image data to the USB wireless LAN terminal 400 via the LAN interface 220. The image receiver 432 of the USB wireless LAN terminal 400 receives the image data via the wireless LAN communication unit 410.

In step S15, the image relaying unit 433 of the USB wireless LAN terminal 400 performs protocol conversion from the IP to the USB protocol with respect to the image data received by the image receiver 432.

In step S16, the image relaying unit 433 of the USB wireless LAN terminal 400 relays the image data as serial data that is in compliance with the USB protocol, to the digital photo frame 500 via the USB interface 420. The digital photo frame 500 receives the image data.

In step S17, the digital photo frame 500 automatically reproduces images from the image data relayed by the USB wireless LAN terminal 400, and displays the images. To put it another way, the digital photo frame 500, if powered on, automatically reproduces images from the image data relayed by the USB wireless LAN terminal 400 without waiting for the operation by the user of the digital photo frame 500.

### (5) Effects of Embodiment

As has been described thus far, according to this embodiment, the server apparatus 200 establishes a VPN connecting with the USB wireless LAN terminal 400 provided with a global IP address. The server apparatus 200 then uses the VPN to transmit image data to the USB wireless LAN terminal 400. The USB wireless LAN terminal 400 receives the image data, and relays the image data to the digital photo frame 500. Then, the digital photo frame 500 reproduces the image data relayed by the USB wireless LAN terminal 400 and displays images reproduced from the image data.

Accordingly, image data can be transmitted via the Internet 10 from the server apparatus 200 located in a house to the digital photo frame 500 located in another house. Consequently, even the user who is not good at operating electronic devices (e.g. an elderly person) can view the images of the image data.

In this embodiment, the USB wireless LAN terminal 400 performs protocol conversion from the IP to the USB protocol with respect to the received image data, and then relays the resultant image data to the digital photo frame 500.

It is quite common that the digital photo frame 500 is provided with a USB interface. Hence, if the USB wireless LAN terminal 400 is connected to the digital photo frame 500, the existing digital photo frame 500 can be used to reproduce image data transmitted from a remote place.

In this embodiment, the server apparatus 200 performs protocol conversion from the USB protocol to the IP with respect to the image data read from the USB memory 100, and then transmits the resultant image data to the USB wireless LAN terminal 400.

Accordingly, the connection of the USB memory 100 to the server apparatus 200 becomes equivalent to the connection of the USB memory 100 to the digital photo frame 500. Consequently, the digital photo frame 500 can automatically reproduces the images from the image data stored in the USB memory 100 and display the images reproduced from the image data.

In this embodiment, the USB wireless LAN terminal 400 receives image data transmitted by means of the wireless LAN communications. Accordingly, the digital photo frame 500 can be easily moved from one place to another, and can receive image data anywhere within the communication area of the wireless LAN base station 300.

### (6) Other Embodiments

This invention has been described above by way of embodiment. However, it should be understood that the description and drawings constituting a part of the disclosure do not limit this invention. Various alternative embodiments, examples, and operational techniques will be apparent from the disclosure for those skilled in the art.

In the embodiments described above, the USB wireless LAN terminal 400 is used as an exemplary communication apparatus of this invention. It is, however, possible that a USB LAN terminal supporting the wired LAN, i.e. a USB wired LAN terminal, be used as a communication apparatus of this invention in place of the USB wireless LAN terminal 400.

In the embodiments described above, the server apparatus 200 is used as an exemplary information processing apparatus of this invention. It is, however, possible that an ordinary PC be used as an information processing apparatus of this invention in place of the server apparatus 200.

In the embodiments described above, the USB memory 100 is used as an exemplary storage medium of this invention connected to the information processing apparatus. It is, however, possible that a memory card storing image data be used, in place of the USB memory 100, as a storage medium of this invention connected to the information processing apparatus. In this case, the connection of the memory card to the server apparatus 200 becomes equivalent to the connection of the memory card to the digital photo frame 500. Hence, the digital photo frame 500 can automatically reproduce the image data stored in the memory card and display images reproduced from the image data.

In the embodiments described above, the image data is assumed to be still image data. It is, however, possible that the image data be motion picture data. In this case, however, the digital photo frame 500 must be so designed as to be able to reproduce motion pictures.

What is claimed is:

1. A communication system comprising:
an information processing apparatus capable of communicating via the Internet;
an image reproducing apparatus for reproducing image data and displaying images reproduced from the image data; and
a communication apparatus which is connected to the image reproducing apparatus and provided with a global IP (Internet Protocol) address,
wherein
the information processing apparatus includes:
a communication establishing unit for establishing via the Internet an IP-communication channel linked with the communication apparatus provided with the global IP address, and
an image transmitter for transmitting image data to the communication apparatus via the IP-communication channel established by the communication establishing unit;
the communication apparatus includes:
an image receiver for receiving the image data transmitted by the image transmitter, and
an image relaying unit for relaying the image data received by the image receiver to the image reproducing apparatus; and
the image reproducing apparatus reproduces the image data relayed by the image relaying unit and displays images reproduced from the image data.

2. The communication system according to claim 1, wherein
the image transmitter transmits the image data to the communication apparatus in compliance with the IP,
the communication apparatus further includes a communication-apparatus-side interface built in compliance with a predetermined interface protocol and connected to the image reproducing apparatus, and
the image relaying unit performs protocol conversion from the IP to the predetermined interface protocol with respect to the image data received by the image receiver, and then relays the resultant image data to the image reproducing apparatus via the communication-apparatus-side interface.

3. The communication system according to claim 2, wherein
the information processing apparatus further includes:
an information-processing-apparatus-side interface which is built in compliance with the predetermined interface protocol and to which a storage medium is connected; and
an image reading unit for reading image data from the storage medium connected to the information-processing-apparatus-side interface, and
the image transmitter performs protocol conversion from the predetermined interface protocol to the IP with respect to the image data read by the image reading unit, and then transmits the resultant image data to the communication apparatus.

4. The communication system according to claim 2, wherein the predetermined interface protocol is the USB (universal serial bus) protocol.

5. The communication system according to claim 1, wherein
the communication apparatus further includes a wireless LAN communication unit for communicating wirelessly with a wireless LAN base station connected to the Internet,
the image transmitter transmits image data to the communication apparatus via the Internet and the wireless LAN base station, and
the image receiver receives the image data via the wireless LAN communication unit.

6. A communication apparatus comprising:
a communication-apparatus-side interface which is built in compliance with a predetermined interface protocol and which is connected to an image reproducing apparatus for reproducing image data and displaying images reproduced from the image data;
an image receiver for receiving image data transmitted by an information processing apparatus by using an IP-communication channel via the Internet after a global IP address has been set in the communication apparatus; and
an image relaying unit for performing protocol conversion from the IP to the predetermined interface protocol with respect to the image data received by the image receiver, and then relaying the resultant image data to the image reproducing apparatus via the communication-apparatus-side interface.

7. A communication method comprising:
the step of causing an information processing apparatus capable of communicating via the Internet, to establish via the Internet an IP-communication channel reaching a communication apparatus which is connected to the image reproducing apparatus by using a predetermined interface and is provided with a global IP address;
the step of causing the information processing apparatus to transmit image data to the communication apparatus by using the IP-communication channel established in the preceding step;
the step of causing the communication apparatus to receive the image data transmitted by the information processing apparatus and to relay the received image data to the image reproducing apparatus; and
the step of causing the image reproducing apparatus to receive the image data relayed by the communication apparatus and to reproduce the received image data for display.
